(19) United States
(12) Patent Application Publication
(10) Pub. No.: US 2010/0024810 A1
(43) Pub. Date: Feb. 4, 2010

(54) DECRYSTALLIZATION OF CELLULOSIC BIOMASS WITH AN ACID MIXTURE COMPRISING PHOSPHORIC AND SULFURIC ACIDS

(75) Inventors: MARK ANDREW HARMER, Landenberg, PA (US); Ann Y. Liauw, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/505,796

(22) Filed: Jul. 20, 2009

Related U.S. Application Data
(60) Provisional application No. 61/085,165, filed on Jul. 31, 2008.

(51) Int. Cl. C13K 1/02

(52) U.S. Cl. 127/37

(57) ABSTRACT

The present invention provides a process for treating biomass to produce sugars. The process is directed to decrystallizing cellulose by contacting biomass with an acid mixture comprising sulfuric acid and phosphoric acid at particular molar ratios. Following decrystallization, the biomass may be hydrolyzed with the acid mixture to produce a saccharification product comprising sugars.

### CROSS-REFERENCE TO RELATED APPLICATIONS

This application claims benefit of priority from Provisional Application No. 61/085,165, filed Jul. 31, 2008.

### FIELD OF THE INVENTION

Methods for treating biomass to obtain sugars are provided. Specifically, decrystallization of cellulose in biomass with an acid mixture comprising phosphoric acid and sulfuric acid followed by hydrolysis, provides a saccharification product in high yield.

### BACKGROUND

Cellulosic and lignocellulosic feedstocks and wastes, such as agricultural residues, wood, forestry wastes, sludge from paper manufacture, and municipal and industrial solid wastes, provide a potentially large renewable feedstock for the production of valuable products such as fuels and other chemicals. Cellulosic and lignocellulosic feedstocks and wastes, composed of carbohydrate polymers comprising cellulose, hemicellulose, glucans, and lignin are generally treated by a variety of chemical, mechanical and enzymatic means to release primarily hexose and pentose sugars, which can then be fermented to useful products.

Pretreatment methods are used to make the carbohydrate polymers of cellulosic and lignocellulosic materials more readily available for saccharification. Standard pretreatment methods have historically utilized primarily strong acids at high temperatures; however due to high energy costs, high equipment costs, high pretreatment catalyst recovery costs and incompatibility with enzymes which may be used for saccharification, alternative methods are being developed, such as enzymatic pretreatment, or the use of acid or base at milder temperatures where decreased hydrolysis of biomass carbohydrate polymers occurs during pretreatment, requiring improved enzyme systems to saccharify both cellulose and hemicellulose.

A number of pretreatment methods utilizing phosphoric acid or sulfuric acid have been disclosed. For example, U.S. Pat. No. 4,058,411 discloses a process for decrystallizing cellulose in natural cellulosic material through the use of concentrated H₃PO₄, which is extracted and recycled. The H₃PO₄ ranges in concentration from 80 weight percent to 85 weight percent.

U.S. Pat. No. 5,486,068 discloses a process for treating wood, wood wastes, paper, and/or other types of polysaccharides (matter composed essentially of cellulose and lignin) with concentrated sulfuric acid (93 to 98.5% H₂SO₄), or with concentrated phosphoric acid (75 to 85% H₃PO₄), or various mixtures of these acids in their concentrated forms. The product of the process, dry solid compositions of matter, can be used for treating agricultural soils or as a landfill.

U.S. Pat. Nos. 5,417,984 and 5,674,507 disclose a method to prepare low crystallinity cellulose by reacting cellulose materials with 85% or higher weight percentage phosphoric acid under controlled sequenced temperature conditions.

Published PCT patent application WO 02/02826 describes a process for production of fermentable sugar from cellulose-containing raw materials which are hydrolyzed with an acid-containing solution, particularly comprising sulfuric acid, whereupon the acid is removed from the mixture with an extraction agent. The method is characterized in that a mixture of a lower alcohol and a lower ketone is used as extraction agent.

Published PCT patent application WO 2007/111605 describes a process and system for the efficient fractionation of lignocellulosic biomass into cellulose, hemicellulose, sugars, lignin, and acetic acid. One step of the process combines a first solvent with the lignocellulosic biomass; another process step combines a second solvent with the material from the previous step. The first solvent comprises one or more chemicals selected from the group consisting of hydrochloric acid, sulfuric acid, nitric acid, phosphoric acid, polyphosphoric acid, acetic acid, sulfur dioxide, zinc chloride, sodium hydroxide, potassium hydroxide, ammonia, among other chemicals or chemical combinations.

Efficient decrystallization of cellulose in biomass and the ability to provide a higher loading of carbohydrates available for hydrolysis (saccharification) would be advantageous for a commercial process for the production of fermentable sugars from a renewable resource biomass. Such advantages would make a process to provide high yields of sugars at high concentrations economically competitive.

### SUMMARY

The present invention provides a method for achieving said advantages by treating biomass to produce sugars. An aspect of the invention is a process for decrystallizing cellulose in biomass comprising contacting biomass with an acid mixture comprising sulfuric acid and phosphoric acid. The use of acid mixtures comprising phosphoric acid and sulfuric acid in molar ratios ranging from 3.39:1 to 0.21:1 has been found to provide efficient decrystallization of cellulose in a controllable manner, and to enable a higher loading of carbohydrates available for saccharification, in contrast to the use of only sulfuric acid or only phosphoric acid for biomass pretreatment. Following decrystallization, the biomass may be hydrolyzed with the acid mixture to produce a saccharification product comprising sugars.

In one embodiment of the invention, the process for decrystallizing cellulose in biomass comprises:

(a) providing biomass comprising cellulose;

(b) contacting the biomass with an acid mixture comprising phosphoric acid and sulfuric acid to form a biomass/acid mixture; and

(c) maintaining the biomass/acid mixture for a reaction time and a temperature sufficient to produce a decrystallized biomass product; wherein
(i) the molar ratio of phosphoric acid to sulfuric acid in the acid mixture is from about 3.39:1 to about 0.21:1; and
(ii) the ratio of the weight of biomass to the weight of the acid mixture is from about 1:0.5 to about 1:5.

Biomass refers to any cellulosic or lignocellulosic material, for example, bioenergy crops, agricultural residues, municipal solid waste, industrial solid waste, yard waste, wood, forestry waste and combinations thereof. According to the process of the invention, the decrystallized biomass product may contain water, and the weight percent of water is from about 3 weight percent to about 30 weight percent, based on the total weight of the biomass, the acid mixture, and the water. In one embodiment, the weight percent of water may be from about 5 weight percent to about 20 weight percent. In one embodiment, the molar ratio of phosphoric acid to sulfuric acid in the acid mixture may be from about 1.98:1 to about 0.36:1. In one embodiment, the ratio of the weight of biomass to the weight of the acid mixture may be from about 1:0.5 to about 1:2. In one embodiment, the temperature may be from about 0° C. to about 50° C. In one embodiment, the temperature may be from about 15° C. to about 25° C. In one embodiment, the reaction time may be up to about 72 hours.

In an embodiment, the reaction time may be up to about 24 hours. In an embodiment, steps (a), (b), (c), or a combination thereof may be repeated at least one time. In an embodiment, at least about 50% of the cellulose in the provided biomass may be decrystallized in the decrystallized biomass product. In an embodiment, at least about 70% of the cellulose may be decrystallized in the decrystallized biomass product. In one embodiment, at least about 90% of the cellulose may be decrystallized in the decrystallized biomass product. In addition, energy may be applied to the biomass before or during step (a), before or during step (b), before or during step (c), or a combination thereof in order to reduce the size, increase the exposed surface area, and/or increase the accessibility of cellulose, hemicellulose, and/or oligosaccharides present in the biomass.

In one embodiment of the invention, the process for saccharification of biomass comprises:

(a) providing biomass comprising cellulose;

(b) contacting the biomass with an acid mixture comprising phosphoric acid and sulfuric acid to form a biomass/acid mixture;

(c) maintaining the biomass/acid mixture for a first reaction time and at a first temperature sufficient to produce a decrystallized biomass product;

(d) adding water to the decrystallized biomass product, wherein the amount of water is from about 20 weight percent to about 200 weight percent based on the combined weight of biomass and the acid mixture; and

(e) maintaining the water and decrystallized biomass product for a second reaction time and at a second temperature sufficient to produce a saccharification product; wherein
(i) the molar ratio of phosphoric acid to sulfuric acid in the acid mixture is from about 3.39:1 to about 0.21:1; and
(ii) the ratio of the weight of biomass to the weight of the acid mixture is from about 1:0.5 to about 1:5.

According to the process of the invention, the second reaction time may be from about 1 to about 16 hours. According to the process of the invention, the second temperature may be from about 50° C. to about 100° C. In one embodiment, the molar ratio of phosphoric acid to sulfuric acid in the acid mixture may be from about 1.98:1 to about 0.36:1. The decrystallized biomass product contains water, and the weight percent of water may be from about 3 weight percent to about 30 weight percent, based on the total weight of the biomass, the acid mixture, and the water. The saccharification product comprises at least one sugar selected from the group consisting of glucose, cellobiose, and xylose or a combination thereof. In addition, the liquid in the saccharification product may be separated from solids, and the liquid may be optionally washed with water.

### BRIEF DESCRIPTION OF THE FIGURES

FIG. 1 shows the X-ray diffraction patterns of corn cob samples before (line 10) and after (line 20) decrystallization, showing the reflections typical of crystalline cellulose and their loss, respectively.

FIG. 2 shows a representation of an optical micrograph showing the decrystallization of corn cob after 5 minutes in the presence of a 50:50 mixture of phosphoric and sulfuric acid.

FIG. 3 shows a representation of an optical micrograph showing the decrystallization of corn cob after 60 minutes in the presence of a 50:50 mixture of phosphoric and sulfuric acid.

FIG. 4 shows a representation of an optical micrograph showing the decrystallization of corn cob after 1.5 hours in the presence of a 70:30 mixture of phosphoric and sulfuric acid.

FIG. 5 shows a representation of an optical micrograph showing the decrystallization of corn cob after 16 hours in the presence of a 70:30 mixture of phosphoric and sulfuric acid.

### DETAILED DESCRIPTION OF THE INVENTION

Where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

Where a range of numerical values is recited herein, unless otherwise stated, the range is intended to include the endpoints thereof, and all integers and fractions within the range. It is not intended that the scope of the invention be limited to the specific values recited when defining a range.

The term “fermentable sugar” refers to oligosaccharides and monosaccharides that can be used as a carbon source by a microorganism in a fermentation process.

The term “lignocellulosic” refers to a composition comprising both lignin and cellulose. Lignocellulosic material may also comprise hemicellulose.

The term “cellulosic” refers to a composition comprising cellulose.

The term “target chemical” refers to a chemical produced by fermentation. Chemical is used in a broad sense and includes molecules such as proteins, including, for example, peptides, enzymes, and antibodies. Examples of target chemicals include ethanol and butanol.

The term “saccharification” refers to the production of fermentable sugars from polysaccharides.

The term “pretreated biomass” means biomass that has been subjected to pretreatment prior to saccharification.

The term “biomass” refers to any cellulosic or lignocellulosic material and includes materials comprising cellulose, and optionally further comprising hemicellulose, lignin, starch, oligosaccharides and/or monosaccharides. Biomass may also comprise additional components, such as protein and/or lipid. According to the invention, biomass may be derived from a single source, or biomass can comprise a mixture derived from more than one source; for example, biomass could comprise a mixture of corn cobs and corn stover, or a mixture of grass and leaves. Biomass includes, but is not limited to, bioenergy crops, agricultural residues, municipal solid waste, industrial solid waste, sludge from paper manufacture, yard waste, wood and forestry waste or a combination thereof. Examples of biomass include, but are not limited to, corn grain, corn cobs, crop residues such as corn husks, corn stover, grasses, wheat, wheat straw, barley, barley straw, hay, rice straw, switchgrass, waste paper, sugar cane bagasse, sorghum, soy, components obtained from milling of grains, trees, branches, roots, leaves, wood chips, sawdust, shrubs and bushes, vegetables, fruits, flowers, and animal manure or a combination thereof. In one embodiment, biomass that is useful for the invention includes biomass that has a relatively high carbohydrate value, is relatively dense, and/or is relatively easy to collect, transport, store and/or handle. In one embodiment of the invention, biomass that is useful includes corn cobs, corn stover, sawdust, and sugar cane bagasse.

In the present method, decrystallization of cellulose, and optionally hemicellulose, occurs rapidly and in a controllable manner, avoiding undesirable exotherms, when biomass is contacted with an acid mixture comprising phosphoric acid and sulfuric acid. The ratio of phosphoric acid to sulfuric acid in the acid mixture is from about 3.39:1 to about 0.21:1 on a molar basis, for example from about 1.98:1 to about 0.36:1, or for example from about 1.27:1 to about 0.56:1. The ratio of phosphoric acid to sulfuric acid in the acid mixture can also be 1:1 on a molar basis.

The ratio of phosphoric acid to sulfuric acid in the acid mixture can also be conveniently expressed as the ratio of the weight of concentrated phosphoric acid solution to the weight of concentrated sulfuric acid solution used to prepare the acid mixture. The ratio by weight of concentrated phosphoric acid solution to the weight of concentrated sulfuric acid solution in the acid mixture is from about 20:80 to about 80:20, for example from about 30:70 to about 70:30, for example from about 40:60 to about 60:40, for example about 50:50. By concentrated phosphoric acid solution is meant a solution containing about 85 wt % phosphoric acid (H₃PO₄). By concentrated sulfuric acid solution is meant a solution containing about 98 weight percent sulfuric acid (H₂SO₄). The acid mixture can contain water from the concentrated acid solutions. In one embodiment, the acid mixture consists essentially of phosphoric acid, sulfuric acid, and water.

Alternatively, it is possible to use fuming sulfuric acid (oleum) in place of a concentrated sulfuric acid solution, or in combination with a concentrated sulfuric acid solution, to provide the desired amount of sulfuric acid in the acid mixture. Similarly, it is possible to use a source of phosphoric acid which is greater than 85 weight percent phosphoric acid, in place of or in combination with a concentrated phosphoric acid solution, to provide the desired amount of phosphoric acid in the acid mixture. In these cases, the rate of contacting biomass with the acid mixture, the order of addition, and effective mixing can be key variables for controlling the rate of decrystallization.

In the present method, the amount of water contained in or on the biomass in combination with the amount of water contained in the acid mixture is from about 3 weight percent to about 30 weight percent, for example from about 5 weight percent to about 20 weight percent, based on the combined weight of the biomass and the acid mixture. Decrystallization of cellulose is enhanced at lower water content.

In the present method, the ratio of the weight of biomass to the weight of the acid mixture is from about 1:0.5 to about 1:5, or for example from about 1:0.5 to about 1:2. The percent of biomass, or biomass concentration, in the combination of biomass and the acid mixture, is kept high to minimize the need for concentration of sugars resulting from saccharification of the decrystallized biomass for use in fermentation. The high biomass concentration also reduces the total volume of pretreatment material, making the process more economical. From a practical viewpoint, high ratios of the weight of biomass to the weight of the acid mixture can be limited by the ability to provide sufficient mixing, or intimate contact, for decrystallization to occur at a practical rate. For example, with high ratios it may be necessary to use an extruder or similar equipment to provide sufficient mixing.

The biomass may be used directly as obtained from the source, or energy may be applied to the biomass to reduce the size, increase the exposed surface area, and/or increase the availability of cellulose, hemicellulose, and/or oligosaccharides present in the biomass to the acids. Energy means useful for reducing the size, increasing the exposed surface area, and/or increasing the availability of cellulose, hemicellulose, and/or oligosaccharides present in the biomass include, but are not limited to, milling, crushing, grinding, shredding, chopping, disc refining, ultrasound, and microwave. This application of energy may occur before or during pretreatment, before and during saccharification, or any combination thereof.

It is often advantageous to apply energy to the biomass, for example corn cob, to reduce the size of the particles before decrystallization with the acid mixture. The appropriate size range of the biomass particles can be determined by observing the decrystallization reaction. If the biomass particles are too small, the decrystallization reaction can be very fast and difficult to control due to exotherms. This is particularly true when sulfuric acid alone, without any phosphoric acid, is used. If the biomass particles are too large, the decrystallization reaction will be slowed and decomposition or degradation of the cellulose and hemicellulose in the reaction mixture will occur, which reduces the overall sugar yield after hydrolysis. Appropriately sized particles will allow the decrystallization to proceed in a controllable manner without exotherms, and the amount of decomposition or degradation is minimized. For example, with a 70:30 (weight:weight) mixture of phosphoric and sulfuric acids, 2 mm corn cob particles can be decrystallized over 16 hours at room temperature; if the corn cob particles are reduced to 0.5 mm in size, decrystallization can be complete within about 3 hours. Some types of biomass, for example sugar cane bagasse, can be used as obtained or with only minimal application of energy for size reduction.

The decrystallization of biomass with an acid mixture comprising phosphoric acid and sulfuric acid carried out at a temperature of from about 0° C. to about 50° C., for example from about 15° C. to about 25° C.

The decrystallization of biomass with an acid mixture comprising phosphoric acid and sulfuric acid is carried out for a reaction time up to about 72 hours. Longer periods of contact are possible, however a shorter period of time may be preferable for practical, economic reasons. Typically a period of acid contact is about 24 hours or less. Longer periods may provide the benefit of reducing the need for application of energy for breaking-up the biomass. The decrystallization time can also be controlled by varying the phosphoric to sulfuric acid ratio. The higher the relative amount of sulfuric acid, the faster the rate of decrystallization.

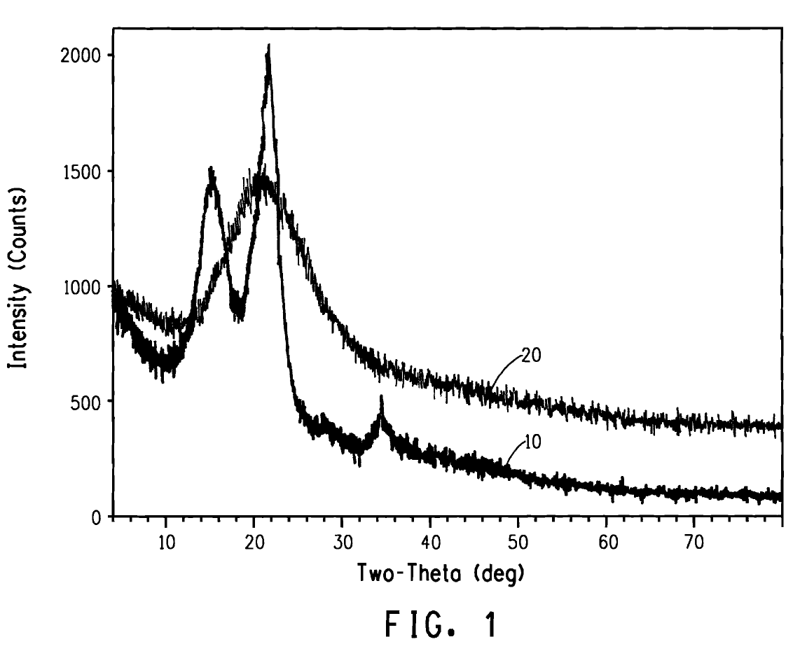

The reduction in crystallinity of the cellulose within the biomass can be observed using X-ray diffraction. FIG. 1 shows the X-ray diffraction patterns of corn cob samples before (line 10) and after (line 20) decrystallization with an acid mixture comprising phosphoric acid and sulfuric acid. The original, untreated corn cob shows distinct crystalline peaks (16, 22, and 34.5 (2-Theta)) corresponding to the 101, 002, and 040 planes respectively for crystalline cellulose. These peaks are reduced to a broad peak following decrystallization.

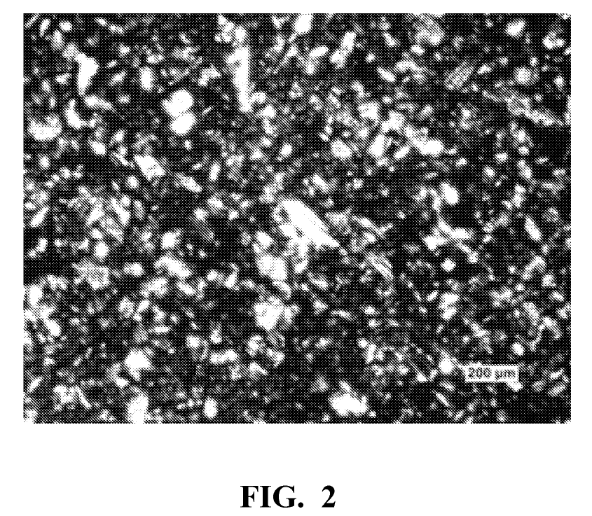

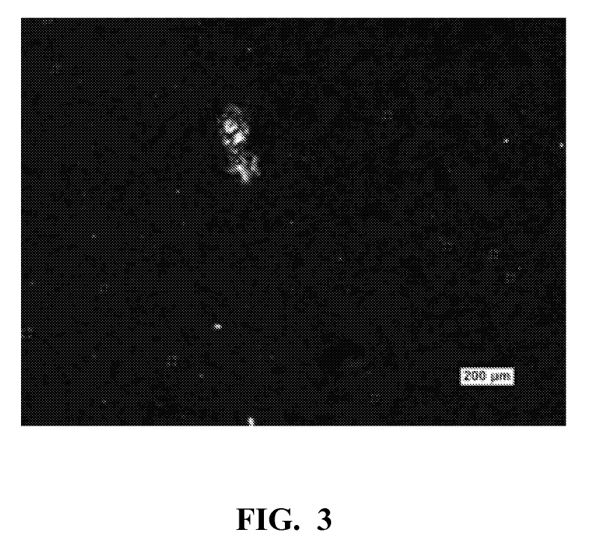

Decrystallization of cellulose in biomass with acid mixtures comprising phosphoric acid and sulfuric acid can also be observed using a polarizing microscope. For example, milled corn cob particles can be mixed with the acid mixture, then placed between two glass slides and monitored by optical microscopy over time. FIG. 2 shows a representation of an optical micrograph showing the decrystallization of corn cob (about 0.1 mm to 0.3 mm in size) after 5 minutes in the presence of a 50:50 mixture of phosphoric acid and sulfuric acid. The crystalline particles appear white and darken upon decrystallization, allowing a visual estimate to be made of the extent of decrystallization based upon the area that darkens. After about 1 hour at room temperature, the corn cob is almost completely decrystallized, as seen in FIG. 3.

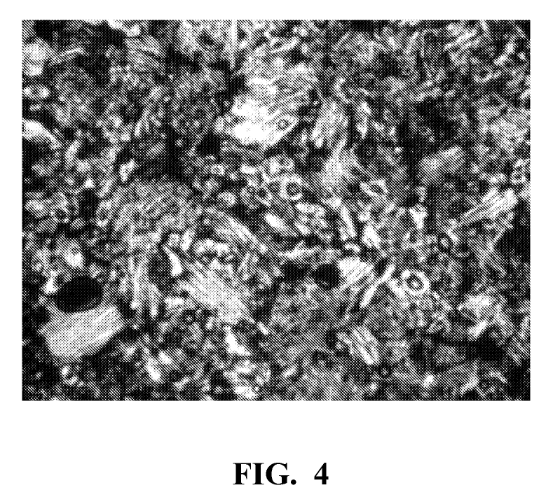

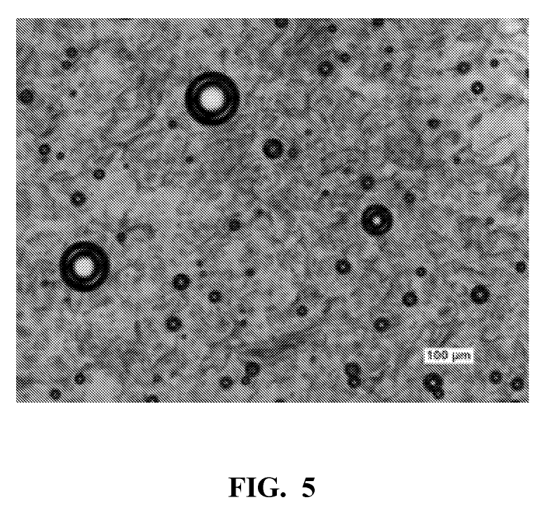

FIG. 4 shows the partial decrystallization of corn cob (about 0.1 mm to 0.3 mm in size) after 1.5 hours using a 70:30 mixture of phosphoric acid and sulfuric acid. FIG. 5 shows a fully decrystallized sample of corn cob after 16 hours using transmitted light.

In one embodiment of the invention, at least about 50% of the cellulose in the provided biomass is decrystallized in the decrystallized biomass product. In another embodiment, at least about 70% of the cellulose in the provided biomass is decrystallized. In another embodiment, at least about 90% of the cellulose in the provided biomass is decrystallized. Greater extent of decrystallization leads to improved sugar yield in the saccharification product.

In one embodiment, the decrystallization of biomass with an acid mixture comprising phosphoric acid and sulfuric acid may be performed at a relatively high temperature for a relatively short period of time, for example at from about 25° C. to about 50° C. for about 2 hours to about 24 hours. In another embodiment, the biomass-acid contacting process may be performed at a lower temperature for a longer period of time, for example from about 15° C. to about 25° C. for about 24 hours to about 48 hours. In still another embodiment, the biomass-acid contacting process may be performed at room temperature (approximately 22-25° C.) for a period of time up to about 24 hours. Other temperature and time combinations intermediate to these may also be used.

For the decrystallization of biomass with an acid mixture comprising phosphoric acid and sulfuric acid, the temperature, reaction time, weight percent of total water in the contacting of biomass with the acid mixture, the biomass concentration, the biomass type, and the biomass particle size are related; thus these variables may be adjusted as necessary to obtain sufficient decrystallization rate in a controllable manner and to obtain an optimal product for hydrolysis to sugars.

The decrystallization of cellulose in biomass may be performed in any suitable vessel, such as a batch reactor or a continuous reactor. The suitable vessel may be equipped with a means, such as impellers, for agitating the biomass/acid mixture. Reactor design is discussed in Lin, K.-H., and Van Ness, H. C. (in Perry, R. H. and Chilton, C. H. (eds), Chemical Engineer's Handbook, 5^{th} Edition (1973) Chapter 4, McGraw-Hill, NY). The decrystallization reaction may be carried out as a batch process, or as a continuous process.

In order to obtain sufficient quantities of sugars from biomass, the biomass may be decrystallized with an acid mixture one time or more than one time. Likewise, a saccharification reaction can be performed one or more times. Both decrystallization and saccharification processes may be repeated if desired to obtain higher yields of sugars. To assess performance of the decrystallization and saccharification processes, separately or together, the theoretical yield of sugars derivable from the starting biomass can be determined and compared to measured yields.

After the decrystallization, the decrystallized biomass product comprises a mixture of phosphoric acid, sulfuric acid, water, partially degraded biomass, and fermentable sugars. Water is added to the decrystallized biomass product, which is then hydrolyzed using the acid from the decrystallization step. The amount of water added is from about 20 weight percent to about 200 weight percent based on the combined weight of biomass and the acid mixture. According to the present method, the use of an acid mixture comprising phosphoric acid and sulfuric acid necessitates less dilution for saccharification than a sulfuric acid-only system (since, with an equivalent water addition, in the mixed acid system the resulting sulfuric acid concentration is lower than in a sulfuric acid-only decrystallization system), with the added advantage that the resulting lower sulfuric acid concentration during saccharification leads to less xylose decomposition. As xylose decomposition increases the yield loss of sugars through saccharification, it is not desired. The use of an acid mixture comprising phosphoric acid and sulfuric acid also provides effective saccharification in a controllable manner.

The saccharification reaction is performed with a mixture of phosphoric acid and sulfuric acid at a temperature of from about 50° C. to about 100° C., for example from about 70° C. to about 90° C.

The saccharification reaction is carried out for a reaction time of about 30 minutes to about 16 hours, for example from about 1 hour to about 8 hours. The time for the reaction will depend on the ratio of phosphoric acid to sulfuric acid in the decrystallized biomass product, the pH of the diluted decrystallized biomass product mixture, the reaction temperature, the substrate used, and the concentration of the acid, higher acid concentrations giving faster reaction times. These variables may be adjusted as necessary to obtain an optimal saccharification product for use in fermentation.

The saccharification reaction may be performed in any suitable vessel, such as a batch reactor or a continuous reactor. The suitable vessel may be equipped with a means, such as impellers, for agitating the biomass/acid mixture. Reactor design is discussed in Lin, K.-H., and Van Ness, H. C. (in Perry, R. H. and Chilton, C. H. (eds), Chemical Engineer's Handbook, 5^{th} Edition (1973) Chapter 4, McGraw-Hill, NY).

The saccharification can be performed batch-wise or as a continuous process. The saccharification can also be performed in one step, or in a number of steps. For example, different reaction temperatures may be employed, or different pH conditions, during the course of the saccharification reaction.

The degree of solubilization of sugars from biomass following saccharification can be monitored by measuring the release of monosaccharides and oligosaccharides. Methods to measure monosaccharides and oligosaccharides are well known in the art. For example, the concentration of reducing sugars can be determined using the 1,3-dinitrosalicylic (DNS) acid assay (Miller, G. L., Anal. Chem. (1959) 31:426-428). Alternatively, sugars can be measured by HPLC using an appropriate column as described herein in the Experimental Section.

Following saccharification, liquid in the saccharification product may be separated from solids, for example lignin, in a batch or continuous method. Optionally, the liquid may be washed with water. The saccharification mixture may be concentrated by evaporation, for example, to increase the concentration of fermentable sugars.

Fermentable sugars in the saccharification product, for example glucose, xylose, and cellobiose, can be used by suitable microorganisms to produce target chemicals. Target chemicals include, for example, acids, alcohols, alkanes, alkenes, aromatics, aldehydes, ketones, biopolymers, proteins, peptides, amino acids, vitamins, antibiotics, and pharmaceuticals.

### EXAMPLES

The present invention is further defined in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

The following materials were used in the examples. All commercial reagents were used as received.

Concentrated sulfuric acid (98%), GR ACS 95-98% purity grade, was obtained from EMD BioScience (USA). Concentrated phosphoric acid (85%), ACS reagent grade, was obtained from Sigma-Aldrich (St. Louis, Mo.). Glucose, ACS reagent grade, was obtained from Sigma-Aldrich. Xylose, minimum 99% purity, was obtained from Sigma-Aldrich. Cellobiose, ACS purity, was obtained from Sigma-Aldrich. Corn cob, milled with a hammer mill, was obtained from Independence Corn By-Products (Independence, Iowa). Sugar cane bagasse was obtained from a sugar mill.

The meaning of abbreviations is as follows: “g” means gram(s), “h” means hour(s), “wt %” means weight percent, HPLC means High Performance Liquid Chromatography, “C” is Centigrade, “mL” is milliliter, “N” means normal.

A modified version of the NREL LAP procedure “Determination of Structural Carbohydrates and Lignin in Biomass” was used to determine the weight percent glucan and xylan in the biomass. Sample preparation was simplified by drying at 80° C. under vacuum or at 105° C. under ambient pressure overnight. The samples were knife milled to pass through a 20 mesh screen but were not sieved. The dry milled solids were than subjected to the acid hydrolysis procedure at a 50 mg solids scale. The solids were not first extracted with water or ethanol. HPLC analysis of sugars was done on an Aminex HPX-87H column and no analysis of lignin was attempted.

The soluble sugars glucose, cellobiose, and xylose in saccharification liquor were measured by HPLC (Waters Alliance Model, Milford, Mass.) using Bio-Rad HPX-87H column (Bio-Rad Laboratories, Hercules, Calif.) with appropriate guard columns, using 0.01 N aqueous sulfuric acid as the eluant. The sample pH was measured and adjusted to 5-6 with sulfuric acid if necessary. The sample was then passed through a 0.2 μm syringe filter directly into an HPLC vial. The HPLC run conditions were as follows:
Biorad Aminex HPX-87H (for carbohydrates):
Injection volume: 10 - 50 μL, dependent on concentration and detector limits
Mobile phase: 0.01 N aqueous sulfuric acid, 0.2 μm filtered and degassed
Flow rate: 0.6 mL/minute
Column temperature: 50° C., guard column temperature<60° C.
Detector temperature: as close to main column temperature as possible
Detector: refractive index
Run time: 15 minute data collection
   After the run, concentrations in the sample were determined from standard curves for each of the compounds.

The milled corn cob used as biomass in Examples 1-4, 6-9, 11, 12, and the Comparative Example was prepared as follows. Corn cob particles of about 2-5 mm size (100 g) and water (400 g) were combined in a Warring blender (model HGB7WTG4) on setting 7 for one hour. The resulting mixture was filtered with a sintered glass filter and the solids then dried overnight at 85° C. under flowing nitrogen gas. The dried solids were then sieved with a 0.5 mm metal sieve. Approximately 95% of the solids passed through the sieve, indicating the particles were up to 0.5 mm in size. The milled, dried corn cob particles which passed through the sieve were used in the specified Examples. Based on the measured glucan and xylan levels of the corn cob, theoretical yields of glucose and xylose were calculated to be 39 g and 31 g, respectively, for 100 g of milled, dried corn cob particles.

The corn cob used as biomass in Examples 14-21 was milled with a hammer mill or a Wiley mill and screened to obtain particles having the indicated sizes. The theoretical yields of glucose and xylose were within the same range as for the corn cob used in the other Examples.

To determine the residual moisture level in the milled, dried corn cob particles up to 0.5 mm in size, small samples of the milled corn cob particles were weighed, then heated at 140° C. for one hour, then re-weighed to determine the weight of water lost. Residual moisture levels were found to be about 5-7 weight percent by this method.

Based on the measured glucan and xylan levels of the sugar cane bagasse, theoretical yields of glucose and xylose were calculated to be 46 g and 25 g, respectively, for 100 g of bagasse.

The extent of decrystallization of the biomass with time was estimated using a Nikon Polarizing Microscope, Eclipse LV100POL.

### Example 1

In a glass vessel, 2.0 g of milled, dried corn cob particles were combined with 4.0 g of a 70:30 (weight:weight) mixture of concentrated phosphoric acid solution (85% H₃PO₄) and concentrated sulfuric acid solution (98% H₂SO₄). The biomass/acid mixture was stirred with a spatula for fifteen minutes and then left overnight at room temperature with no stirring. Water (6.0 g) was then added; based on the original corn cob loading, the concentration of biomass was now about 16.6 weight percent. The vessel and its contents were heated using an oil bath set to 90° C. The vessel was connected to a reflux condenser. At specific time intervals, 0.5 mL samples of the biomass/acid mixture were taken. Each sample was centrifuged to separate out the solids, and 0.2 mL of the solution was analyzed for sugar content by HPLC. The yields to glucose, xylose, and cellobiose were calculated and are shown in the following Table. After six hours of heating, the reaction mixture was filtered and the filtrate washed with about 5 g of water. About 0.5 g of solids were collected on the filter; the sugars were contained in the filtrate. High yields of sugars were obtained using this method.

### Example 1

### Yields to Glucose, Xylose, and Cellobiose Obtained by Decrystallization of Cellulose Using 70:30 (Weight/Weight) Phosphoric/Sulfuric Acid Mixture Followed by Hydrolysis at 90° C.

| | % Yield to | % Yield to | % Yield to |
|---|---|---|---|
| Time (h) | Glucose | Xylose | Cellobiose |
| 2 | 66 | 87 | 16 |
| 4 | 74 | 84 | 10 |
| 6 | 76 | 81 | 10 |

### Example 2

In a glass vial, 1.0 g of milled, dried corn cob particles were combined with 3.0 g of a 60:40 (weight:weight) mixture of concentrated phosphoric acid solution (85% H₃PO₄) and concentrated sulfuric acid solution (98% H₂SO₄). The biomass/acid mixture was stirred with a spatula for fifteen minutes and then left overnight at room temperature with no stirring. Water (8.0 g) was then added and the vial and its contents were heated using an oil bath set to 100° C. The vial was connected to a reflux condenser. After 5 hours of heating, the solution was filtered while warm, giving 0.23 g of solid and the sugar-containing filtrate. The filtrate was analyzed for sugar content by HPLC. Based on the amount of corn cob used and its composition, the yield of glucose was determined to be 93%, the yield of cellobiose 3%, and the yield of xylose 81%.

### Example 3

In a glass vial, 2.0 g of milled, dried corn cob particles were combined with 5.0 g of a 70:30 (weight:weight) mixture of concentrated phosphoric acid solution (85% H₃PO₄) and concentrated sulfuric acid solution (98% H₂SO₄). The biomass/acid mixture was stirred with a spatula for fifteen minutes and then left for two days at room temperature. Water (8.0 g) was then added and the vial and its contents were heated using an oil bath set to 100° C. The vial was connected to a reflux condenser. After 2 hours of heating, the solution was filtered to remove solids from the sugar-containing solution. The filtrate was analyzed for sugar content by HPLC. Based upon the amount of corn cob used and its composition, the yield of glucose was determined to be 84%, the yield of xylose 76%, and the yield of cellobiose 5.7%.

### Example 4

In a glass vial, 2.0 g of milled, dried corn cob particles were combined with 4.0 g of a 70:30 (weight:weight) mixture of concentrated phosphoric acid solution (85% H₃PO₄) and concentrated sulfuric acid solution (98% H₂SO₄). The biomass/acid mixture was stirred with a spatula for fifteen minutes and then left for three days at room temperature. Water (8.0 g) was then added and the vial and its contents were heated using an oil bath set to 100° C. The vial was connected to a reflux condenser. After 6 hours of heating, the solution was filtered to remove solids from the sugar-containing filtrate. The filtrate was analyzed for sugar content by HPLC. Based upon the amount of corn cob used and its composition, the yield of glucose was determined to be 76%, the yield of xylose 81%, and the yield of cellobiose 10%.

### Example 5

50 g of corn cob (milled to about 2-3 mm in size) was combined with 150 g of a 70:30 (weight:weight) mixture of concentrated phosphoric acid solution (85% H₃PO₄) and concentrated sulfuric acid solution (98% H₂SO₄). The biomass/acid mixture was mixed slowly in an attritor containing 200 g of zirconia milling beads and slowly stirred overnight at room temperature. Water (113 g) was then added and the reaction mixture was heated to 85° C. using a recirculating hot water bath. The mixture was heated for 2 hours. The solution was then filtered to remove solids from the sugar-containing solution. The filtrate was analyzed for sugar content by HPLC. Based upon the amount of corn cob charged and its composition, the yield of glucose was determined to be 60%, the yield of xylose 80%, and the yield of cellobiose 20%.

### Example 6

In a glass vial, 4.0 g of milled, dried corn cob particles were combined with 9.0 g of a 70:30 (weight:weight) mixture of concentrated phosphoric acid solution (85% H₃PO₄) and concentrated sulfuric acid solution (98% H₂SO₄). The biomass/acid mixture was stirred with a spatula for fifteen minutes and then left for two days at room temperature. Water (10.25 g) was then added and the vial and its contents were heated using an oil bath set to 85° C. The vial was connected to a reflux condenser. After 4 hours of heating, the solution was filtered to remove solids from the sugar-containing solution. The filtrate was analyzed for sugar content by HPLC. Based upon the amount of corn cob charged and its composition, the yield of glucose was determined to be 80%, the yield of xylose 85%, and the yield of cellobiose 16.7%.

### Example 7

In a glass vial, 4.0 g of milled, dried corn cob particles were combined with 7.25 g of a 70:30 (weight:weight) mixture of concentrated phosphoric acid solution (85% H₃PO₄) and concentrated sulfuric acid solution (98% H₂SO₄). The biomass/acid mixture was stirred with a spatula for fifteen minutes and then left for two days at room temperature. The material was placed in an oven at 50° C. for 2 hours. 9.25 g of water was then added and the vial and its contents were heated using an oil bath set to 85° C. The vial was connected to a reflux condenser. After 3.5 hours of heating, the solution was filtered to remove solids from the sugar-containing solution. The filtrate was analyzed for sugar content by HPLC. Based upon the amount of corn cob charged and its composition, the yield of glucose was determined to be 79%, the yield of xylose 80%, and the yield of cellobiose 16%.

### Example 8

In a metal bowl, 100 g of milled, dried corn cob particles were combined with 200 g of a 70:30 (weight:weight) mixture of concentrated phosphoric acid solution (85% H₃PO₄) and concentrated sulfuric acid solution (98% H₂SO₄). The biomass/acid mixture was stirred with an overhead mixer for 2 days at room temperature. Water (225 g) was then added. Based on the original corn cob loading, the concentration of biomass was now about 19 weight percent. After heating for 4 hours at 85° C., the reaction mixture was filtered while warm and the filtrate washed with about 20 g of water. About 20 g of solids were collected on the filter. The filtrate contained about 12.5 wt % sugars. Based on the amount of corn cob used and its composition, the yield of glucose was determined to be 80%, the yield of cellobiose 12%, and the yield of xylose 79%.

### Example 9

In a glass vial, 2.0 g of milled, dried corn cob particles were combined with 4.3 g of a 60:40 (weight:weight) mixture of concentrated phosphoric acid solution (85% H₃PO₄) and concentrated sulfuric acid solution (98% H₂SO₄). The biomass/acid mixture was stirred with a spatula for fifteen minutes and then left overnight at room temperature. Water (6.0 g) was then added. Based on the original corn cob loading, the concentration of biomass was now about 16 percent by weight. The vial and its contents were heated using an oil bath set to 90° C. The vial was connected to a reflux condenser. After 7 hours of heating, the solution was filtered to remove solids (0.38 g). The filtrate was analyzed for sugar content by HPLC. Based upon the amount of corn cob used and its composition, the yield of glucose was determined to be 74%, the yield of xylose 79%, and the yield of cellobiose 8%.

### Example 10

In a KitchenAid mixer, 46 g of bagasse were combined with 100 g of a 70:30 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for one day at room temperature. Water was then added to bring the weight to 225 g. Based on the original bagasse loading, the concentration of biomass was now about 20 percent by weight. The mixture was transferred to a glass vessel and heated at 85° C. for 3 hours with good stirring. The solution was filtered to remove solids and the filtrate was analyzed for sugar content by HPLC. Based upon the amount of bagasse used and its composition, the yield of glucose was determined to be 70.5%, the yield of xylose 95%, and the yield of cellobiose 14%.

### Example 11

In a KitchenAid mixer, 83.33 g of milled, dried corn cob particles were combined with 166.6 g of a 70:30 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for three days at room temperature. Water (200 g) was then added. Based on the original corn cob loading, the concentration of biomass was now about 18.5 percent by weight. The mixture transferred to a glass vessel, and the vessel and its contents were heated at 85° C. for 3.5 hours with good stirring. The solution was filtered to remove solids and the filtrate was analyzed for sugar content by HPLC. Based upon the amount of corn cob used and its composition, the yield of glucose was determined to be 79%, the yield of xylose 79%, and the yield of cellobiose 12%.

### Example 12

In a KitchenAid mixer, 100 g of milled, dried corn cob particles were combined with 200 g of a 70:30 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for 2.5 days at room temperature. Water (200 g) was then added. Based on the original corn cob loading, the concentration of biomass was now about 18.5 weight percent. The mixture transferred to a glass vessel, and the vessel and its contents were heated at 80° C. for 3.5 hours with good stirring. The solution was filtered to remove solids and the filtrate was analyzed for sugar content by HPLC. Based upon the amount of corn cob used and its composition, the yield of glucose was determined to be 80.7%, the yield of xylose 89%, and the yield of cellobiose 19%.

### Example 13

Bagasse (100 g) was combined with 200 g of a 70:30 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for two days at room temperature. Water (225 g) was then added. Based on the original bagasse loading, the concentration of biomass was now about 18 percent by weight. The mixture was transferred to a glass vessel and heated at 85° C. for 3 hours with good stirring. The solution was filtered to remove solids and the filtrate was analyzed for sugar content by HPLC. Based upon the amount of bagasse used and its composition, the yield of glucose was determined to be 78%, the yield of xylose 76%, and the yield of cellobiose 20%.

### Example 14

Corn cob (50 g, about 1 mm in size ) was combined with 100 g of a 70:30 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for one day at room temperature. Water (100 g) was then added. Based on the original corn cob loading, the concentration of biomass was now about 18.6 percent by weight. The mixture was transferred to a glass vessel and heated at 85° C. for 5 hours with good stirring. The solution was filtered to remove solids and the filtrate was analyzed for sugar content by HPLC. Based upon the amount of corn cob used and its composition, the yield of glucose was determined to be 71%, the yield of xylose 89%, and the yield of cellobiose 18%.

### Example 15

Corn cob (100 g, about 3/16^{th} inch in size) was combined with 200 g of a 70:30 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for one day at room temperature. Water (200 g) was then added. Based on the original corn cob loading, the concentration of biomass was now about 18.6 percent by weight. The mixture was transferred to a glass vessel and heated at 85° C. for 5 hours with good stirring. The solution was filtered to remove solids and the filtrate was analyzed for sugar content by HPLC. Based upon the amount of corn cob used and its composition, the yield of glucose was determined to be 90%, the yield of xylose 90%, and the yield of cellobiose 9%.

### Example 16

Corn cob (100 g, about 0.5 mm in size ) was combined with 150 g of a 50:50 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for one day at room temperature. Water (250 g) was then added. Based on the original corn cob loading, the concentration of biomass was now about 18.6 percent by weight. The mixture was transferred to a glass vessel and heated at 85° C. for 3 hours with good stirring. The solution was filtered to remove solids and the filtrate was analyzed for sugar content by HPLC. Based upon the amount of corn cob used and its composition, the yield of glucose was determined to be 89%, the yield of xylose 91%, and the yield of cellobiose 8%.

### Example 17

Switchgrass (100 g, about 1 mm in size ) was combined with 200 g of a 70:30 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for one day at room temperature. Water (200 g) was then added. Based on the original switchgrass loading, the concentration of biomass was now about 19 percent by weight. The mixture was transferred to a glass vessel and heated at 83° C. for hours with good stirring. The solution was filtered to remove solids and the filtrate was analyzed for sugar content by HPLC. Based upon the amount of switchgrass used and its composition, the yield of glucose was determined to be 80.7% and the yield of xylose 73.5%.

### Example 18

Corn cob (27.8 g, about 2-3 mm in size ) was combined with 41.7 g of a 40:60 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for three days at room temperature. Water (69.3 g) was then added. Based on the original corn cob loading, the concentration of biomass was now about 18 percent by weight. The mixture was transferred to a glass vessel and heated at 83° C. for 3 hours with good stirring. The solution was filtered to remove solids and the filtrate was analyzed for sugar content by HPLC. Based upon the amount of corn cob used and its composition, the yield of glucose was determined to be 78.9% and the yield of xylose 77.2%.

### Example 19

Corn cob (25 g, about 2-3 mm in size ) was combined with 37.5 g of a 40:60 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for one day at room temperature. Water (62.5 g) was then added. Based on the original corn cob loading, the concentration of biomass was now about 20 percent by weight. The mixture was transferred to a glass vessel and heated at 83° C. for 3 hours with good stirring. The solution was filtered to remove solids and the filtrate was analyzed for sugar content by HPLC. Based upon the amount of corn cob used and its composition, the yield of glucose was determined to be 75.1% and the yield of xylose 84%.

### Example 20

Corn cob (100 g, about 2-3 mm in size ) was combined with 130 g of a 30:70 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for eight hours. Water (224 g) was then added. Based on the original corn cob loading, the concentration of biomass was now about 20 percent by weight. The mixture was transferred to a glass vessel and heated at 75° C. for 4 hours with good stirring. The solution was filtered to remove solids and the filtrate was analyzed for sugar content by HPLC. Based upon the amount of corn cob used and its composition, the yield of glucose was determined to be 75.6% and the yield of xylose 76.5%.

### Example 21

Corn cob (100 g, about 0.5 mm in size ) was combined with 150 g of a 40:60 (weight:weight) mixture of concentrated phosphoric acid solution (85% H₃PO₄) and concentrated sulfuric acid solution (98% H₂SO₄). The biomass/acid mixture was mixed with a KitchenAid Industrial mixer for three hours at room temperature. Water (200 g) was then added. Based on the original corn cob loading, the concentration of biomass was now about 18 percent by weight. The mixture was transferred to a glass vessel and heated at 85° C. for 5 hours with good stirring. The solution was filtered to remove solids and the filtrate was analyzed for sugar content by HPLC. Based upon the amount of corn cob used and its composition, the yield of glucose was determined to be 90.4% and the yield of xylose 83.4%.

### Comparative Example

This Comparative Example was performed similarly to Example 1 of published patent application WO 02/02826. 2.5 Grams of milled, dried corn cob particles were added to 8.25 mL of a sulfuric-phosphoric-water mixture (50-20-30 by weight). The mixture was heated to 55° C. and held for 2.5 hours. Water (1.0 mL) was added and the mixture heated at 55° C. for 2.5 additional hours. The reaction mixture was filtered and the composition of sugars in the filtrate was determined. Based upon the corn cob used, the yields of sugars were determined to be glucose 46%, xylose 64% and cellobiose 0%. These values are lower than those obtained using the method of Examples 1-9, 11-16, and 18-21.

Although particular embodiments of the present invention have been described in the foregoing description, it will be understood by those skilled in the art that the invention is capable of numerous modifications, substitutions, and rearrangements without departing from the spirit of essential attributes of the invention. Reference should be made to the appended claims, rather than to the foregoing specification, as indicating the scope of the invention.

What is claimed is:

1. A process for decrystallizing cellulose in biomass comprising:
(a) providing biomass comprising cellulose;
(b) contacting the biomass with an acid mixture comprising phosphoric acid and sulfuric acid to form a biomass/acid mixture; and
(c) maintaining the biomass/acid mixture for a reaction time and a temperature sufficient to produce a decrystallized biomass product; wherein
(i) the molar ratio of phosphoric acid to sulfuric acid in the acid mixture is from about 3.39:1 to about 0.21:1; and
(ii) the ratio of the weight of biomass to the weight of the acid mixture is from about 1:0.5 to about 1:5.

2. The process of claim 1, wherein the molar ratio of phosphoric acid to sulfuric acid in the acid mixture is from about 1.98:1 to about 0.36:1.

3. The process of claim 1, wherein the decrystallized biomass product contains water, and the weight percent of water is from about 3 weight percent to about 30 weight percent, based on the total weight of the biomass, the acid mixture, and the water.

4. The process of claim 3, wherein the weight percent of water is from about 5 weight percent to about 20 weight percent.

5. The process of claim 1, wherein the ratio of the weight of biomass to the weight of the acid mixture is from about 1:0.5 to about 1:2.

6. The process of claim 1, wherein the temperature is from about 0° C. to about 50° C.

7. The process of claim 1, wherein the reaction time is up to about 72 hours.

8. The process of claim 1, wherein (a), (b), (c), or a combination thereof are repeated at least one time.

9. The process of claim 1, wherein at least about 50% of the cellulose in the provided biomass is decrystallized in the decrystallized biomass product.

10. The process of claim 1, wherein at least about 70% of the cellulose in the provided biomass is decrystallized in the decrystallized biomass product.

11. The process of claim 1, wherein biomass is selected from the group consisting of bioenergy crops, agricultural residues, municipal solid waste, industrial solid waste, yard waste, wood and forestry waste or a combination thereof.

12. The process of claim 1, further comprising applying energy before or during (a), before or during (b), before or during (c), or a combination thereof.

13. The process of claim 12, wherein the energy is selected from the group consisting of milling, crushing, grinding, shredding, chopping, disk refining, ultrasound, and microwave.

14. A process for saccharification of biomass, the process comprising:
(a) providing biomass comprising cellulose;
(b) contacting the biomass with an acid mixture comprising phosphoric acid and sulfuric acid to form a biomass/acid mixture;
(c) maintaining the biomass/acid mixture for a first reaction time and at a first temperature sufficient to produce a decrystallized biomass product;
(d) adding water to the decrystallized biomass product, wherein the amount of water is from about 20 weight percent to about 200 weight percent based on the combined weight of biomass and the acid mixture; and
(e) maintaining the water and decrystallized biomass product for a second reaction time and at a second temperature sufficient to produce a saccharification product; wherein
(i) the molar ratio of phosphoric acid to sulfuric acid in the acid mixture is from about 3.39:1 to about 0.21:1; and
(ii) the ratio of the weight of biomass to the weight of the acid mixture is from about 1:0.5 to about 1:5.

15. The process of claim 14, wherein the saccharification product comprises at least one sugar selected from the group consisting of glucose, cellobiose, and xylose or a combination thereof.

16. The process of claim 14, further comprising separating the liquid in the saccharification product from solids, and optionally washing the liquid with water.
